(19) United States
(12) Patent Application Publication
(10) Pub. No.: US 2026/0368217 A1
(43) Pub. Date: Nov. 19, 2026

(54) INFORMATION PROCESSING APPARATUS, INFORMATION PROCESSING METHOD, AND INFORMATION PROCESSING SYSTEM

(71) Applicants: Sukehiro Kimura, KANAGAWA (JP); Toshifumi YAMAAI, KANAGAWA (JP); Tomoki UMEZAWA, KANAGAWA (JP)

(72) Inventors: Sukehiro Kimura, KANAGAWA (JP); Toshifumi YAMAAI, KANAGAWA (JP); Tomoki UMEZAWA, KANAGAWA (JP)

(73) Assignee: Ricoh Company, Ltd., Tokyo (JP)

(21) Appl. No.: 19/671,399

(22) Filed: May 8, 2026

(30) Foreign Application Priority Data
May 19, 2025 (JP) 2025-083104
Jan. 30, 2026 (JP) 2026-014605

(51) Int. Cl. G06F 16/3329; G06F 16/35; G06T 7/60

(52) U.S. Cl. CPC G06F 16/33295; G06F 16/35; G06T 7/60

(57) ABSTRACT

An information processing apparatus includes circuitry to receive input data input from a terminal device, output, to a large-scale language model, a prompt requesting generation of output data corresponding to the input data, and output, to the terminal device, response data to the prompt received from the large-scale language model, wherein the prompt is a prompt requesting generation of the response data by searching a memory with the input data and using a search result as an information source, the memory storing first search target data and second search target data, the first search target data being generated for each of first predetermined range data satisfying a predetermined condition, among predetermined range data included in document data, the second search target data being generated for each of data extracted from second predetermined range data not satisfying the predetermined condition, among the predetermined range data included in the document data.

### CROSS-REFERENCE TO RELATED APPLICATIONS

This patent application is based on and claims priority pursuant to 35 U.S.C. § 119(a) to Japanese Patent Application Nos. 2025-083104, filed on May 19, 2025, and 2026-014605, filed on Jan. 30, 2026, in the Japan Patent Office, the entire disclosure of which is hereby incorporated by reference herein.

### BACKGROUND

### Technical Field

The present disclosure relates to an information processing apparatus, an information processing method, and an information processing system.

### Related Art

In the related art, when generating text data by recognizing character strings contained in a document image acquired by converting a document to an image, techniques have been proposed in which a character learning model that is trained to learn the correspondence between the document image and the character strings contained therein is used.

### SUMMARY

The present disclosure described herein provides an information processing apparatus including circuitry to receive input data input from a terminal device, output, to a large-scale language model, a prompt requesting generation of output data corresponding to the input data, and output, to the terminal device, response data to the prompt received from the large-scale language model, wherein the prompt is a prompt requesting generation of the response data by searching a memory with the input data and using a search result as an information source, the memory storing first search target data and second search target data, the first search target data being generated for each of first predetermined range data satisfying a predetermined condition, among predetermined range data included in document data, the second search target data being generated for each of data extracted from second predetermined range data not satisfying the predetermined condition, among the predetermined range data included in the document data.

The present disclosure described herein provides an information processing method including receiving input data input from a terminal device, outputting, to a large-scale language model, a prompt requesting generation of output data corresponding to the input data, and outputting, to the terminal device, response data to the prompt received from the large-scale language model, wherein the prompt is a prompt requesting generation of the response data by searching a memory with the input data and using a search result as an information source, the memory storing first search target data and second search target data, the first search target data being generated for each of first predetermined range data satisfying a predetermined condition, among predetermined range data included in document data, the second search target data being generated for each of data extracted from second predetermined range data not satisfying the predetermined condition, among the predetermined range data included in the document data.

The present disclosure described herein provides an information processing system including an information processing apparatus, and a terminal device to communicate with the information processing apparatus via a network, the information processing apparatus including circuitry to receive input data input from the terminal device, output, to a large-scale language model, a prompt requesting generation of output data corresponding to the input data, and output, to the terminal device, response data to the prompt received from the large-scale language model, wherein the prompt is a prompt requesting generation of the response data by searching a memory with the input data and using a search result as an information source, the memory storing first search target data and second search target data, the first search target data being generated for each of first predetermined range data satisfying a predetermined condition, among predetermined range data included in document data, the second search target data being generated for each of data extracted from second predetermined range data not satisfying the predetermined condition, among the predetermined range data included in the document data, and wherein the terminal device displays, on a display, the response received from the information processing apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a system configuration of an information processing system according to a first embodiment;

FIG. 2 is a block diagram illustrating a hardware configuration of an information processing apparatus according to the first embodiment;

FIG. 3 is a block diagram illustrating a hardware configuration of a terminal device according to the first embodiment;

FIG. 4 is a block diagram illustrating a functional configuration of each apparatus included in the information processing system according to the first embodiment;

FIG. 5 is a flowchart of a process performed by the information processing apparatus according to the first embodiment;

FIG. 6 is a diagram illustrating a process performed by a classification unit according to the first embodiment;

FIG. 7A and FIG. 7B are diagrams illustrating a screen displayed by the terminal device according to the first embodiment;

FIG. 8 is a sequence diagram illustrating an operation performed by the information processing system according to the first embodiment;

FIG. 9 is a diagram illustrating another screen displayed on the terminal device according to the first embodiment; and

FIG. 10 is a block diagram illustrating a functional configuration of each apparatus included in the information processing system according to the second embodiment;

FIG. 11 is a flowchart of a process performed by the information processing apparatus according to the second embodiment; and

FIG. 12 is a block diagram illustrating a functional configuration of each apparatus included in the information processing system according to the third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### First Embodiment

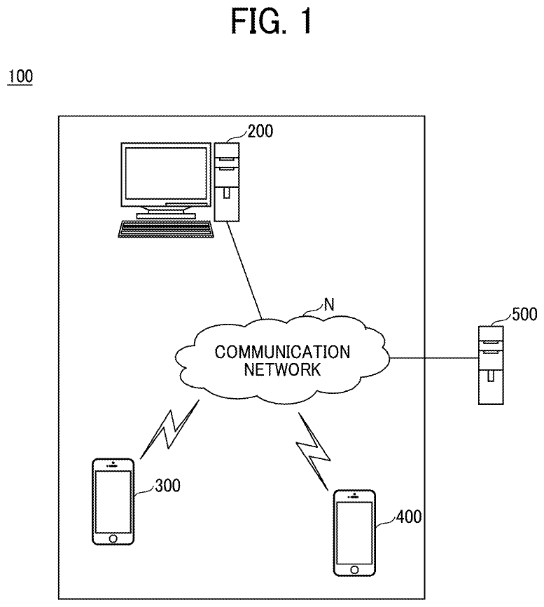

Embodiments of the present disclosure are described below with reference to the drawings. FIG. 1 is a diagram illustrating a system configuration of an information processing system 100 according to a first embodiment.

The information processing system 100 includes an information processing apparatus 200, a terminal device 300 and a terminal device 400. In the information processing system 100, the information processing apparatus 200 and the terminal device 300 are connected to each other via a communication network N. The information processing apparatus 200 communicates with a server apparatus 500 via the communication network N.

The communication network N may be a wide area network such as the Internet or a wide area network (WAN). The communication network N may be a local area network (LAN), Wi-Fi®, a wide area Ethernet®, or a mobile phone network of 4G, 5G, or 6G.

The server apparatus 500 includes a large language model (LLM) and implements a generative artificial intelligence (AI). The generative AI generates output data corresponding to a prompt being input, and outputs the generated output data to the information processing apparatus 200. Chat Generative Pretrained Transformer (GPT) is one example of the generative AI. The term “prompt” refers to text data that describes an instruction or a question to the server apparatus 500 that implements the generative AI. A large language model will be described in detail below.

The terminal device 300 is typically used by a user of the information processing system 100. When the terminal device 300 receives input data such as a question from the user, the terminal device 300 transmits the input data to the information processing apparatus 200. When the terminal device 300 receives response data for the input data from the information processing apparatus 200, the terminal device 300 displays the received response data.

The terminal device 400 is used by, for example, an administrator of a tenant that introduces the information processing system 100. The tenant is an organization such as a company. The tenant may be a group to which the user (the user of the terminal device 300) who uses the information processing system 100 belongs.

The terminal device 400 uploads document data to the information processing apparatus 200 by an operation of the user of the terminal device 400. The document data uploaded from the terminal device 400 is used to generate the response data to the input data input from the terminal device 300. The document data may include, for example, the document data unique to the tenant (organization) that is not open to the public. The document data unique to the tenant includes, for example, in-house document data that is browsed in the company that is the tenant.

When the document data is uploaded from the terminal device 400 to the information processing apparatus 200, the information processing apparatus 200 generates a search target data to be searched by a search query based on the document data, and stores the search target data in a storage unit.

When the information processing apparatus 200 receives the input data from the terminal device 300, the information processing apparatus 200 searches the storage unit by using the input data as a search query to acquire the search target data to generate a prompt for requesting generation of the response data by using the acquired search target data as a source.

The search target data will be described below. The search target data is stored for each of divided data acquired by dividing the document data into predetermined units. In other words, the search target data is stored in the information processing apparatus 200 as chunks acquired by dividing the document data. The chunk is a collection of data. In the information processing apparatus 200, the search target data may be stored in association with identification information for identifying the search target data and identification information for identifying the document data that is a source of the search target data.

Generation of the search target data will be described.

When the document data is uploaded to the information processing apparatus 200, the information processing apparatus 200 classifies data in a predetermined range included in the uploaded document data into data to be converted into an image or data not to be converted into an image.

The document data may be the document data including page image data indicating a page image of each page processed as one page when the document data is output as a printed matter. The document data may be document data having a structured format.

The document data having the structured format is document data described in each predetermined unit according to a predetermined structure. Examples of the predetermined unit includes, for example, a paragraph, a chapter, a clause, or a section. The document data having the structured format includes, for example, document data described in an extensible markup language (XML) format, document data described in a JavaScript® object notation (JSON) format, document data described in a hypertext markup language format, and document data described in a standard generalized markup language (SGML) format.

In the following description, the document data is the document data including the page image data indicating a page image of each page, and the data of the predetermined range is page image data of each page. In the following description, the data in the predetermined range is referred to as predetermined range data. In other words, the page image data of each page included in the document data is the predetermined range data.

In the description, a page to be imaged (a predetermined range to be imaged) may be expressed as a target page to be imaged. In the following description, a page not to be imaged (a predetermined range not to be imaged) may be expressed as a image generation non target page. The target page to be imaged is a first page that satisfies a predetermined condition among pages included in the document data. The page image data representing the first page is first predetermined range data. The image generation non target page is a second page that does not satisfy the predetermined condition among the pages included in the document data. The page image data representing the second page is second predetermined range data. The predetermined condition will be described in detail below.

Specifically, the information processing apparatus 200 extracts an image area and a text area from each page included in the document data, and acquires summary information for each of the extracted image area and text area.

The text area is an area including text data in the document data. The image area is a area circumscribed to an image in the document data. In the present embodiment, the text area and the image area are rectangular areas, but the text area and the image area may not be rectangular.

In the present embodiment, the summary information of the image area is text data indicating a summary of information indicated by the image in the image area, and the summary information of the text area is text data indicating a summary of information indicated by the text data in the text area.

The information processing apparatus 200 determines whether the summary information of the image area extracted from each page is insufficient. The information processing apparatus 200 classifies, as the target page to be imaged (first page), the page including the image area in which the summary information is insufficient among pages included in the document data. The information processing apparatus 200 classifies, as the image generation non target page (second page), a page that does not include an image area lacking summary information among pages included in the document data.

The information processing apparatus 200 generates page image data indicating a page image acquired by imaging the entire page classified as the target page to be imaged among the pages included in the document data, and acquires summary information of the entire page from the page image data. The summary information of the entire page is text data indicating a summary of information indicated by the entire page.

The information processing apparatus 200 sets data in which the page image data and the summary information of the entire page are associated with each other as search target data generated from the target page. The search target data generated from the target page is first search target data.

At this time, the search target data is associated with, for example, the number of pages in the document data as information for specifying a page serving as a source of a page image in the document data.

For a page classified as the image generation non target page among pages included in the document data, the information processing apparatus 200 sets data in which an image in the image area extracted from each page and summary information of the image area are associated with each other as search target data generated from the image generation non target page. At this time, for example, the search target data is associated with information for specifying a page in the document data and position information of an image area for specifying a position of the image area in the page.

The information processing apparatus 200 sets data in which the text data in the text area extracted from the image generation non target page is associated with the summary information of the text area as the search target data generated from the image generation non target page. At this time, in the search target data, information for specifying the page in the document data and position information of the text area for specifying the position of the text area in the page may be associated with each other. The search target data generated from the text area may not include the text data in the text area. In this case, the search target data generated from the text area is only the summary information of the text area.

The search target data generated for each area (text area, image area) extracted from the image generation non target page is second search target data.

The information processing apparatus 200 stores search target data (first search target data and second search target data) generated from each page of document data in a search target storage unit 250 (to be described below).

As described above, the pages included in the document data are classified into an image generation target page and an image generation non target page, and the summary information extracted from the entire pages is included in the search target data only for the pages classified as the image generation target pages. In other words, the data in which the page image data and the summary information acquired from the page image data are associated with each other is set as one chunk (the first search target data) only for the image generation target page in document data.

For the image generation non target page in the document data, the image in the image area extracted from each page and the summary information of the image area are associated with each other to be the search target data (the second search target data). The text data in the text area extracted from the image generation non target page in the document data is associated with the summary information of the text area to be the search target data (the second search target data).

In other words, for the image generation non target page, the search target data including the summary information for each area included in the page is set as one chunk (the second search target data).

The image size in the image area extracted from the image generation non target page is smaller than the size of the page image. Therefore, the second search target data generated from the image area alone has a smaller amount of information than the first search target data generated from the page image.

Therefore, when the second search target data is included in the prompt as the information source of the response data to the input data, the number of tokens in the prompt can be reduced as compared with the case where the first search target data is included in the prompt. Accordingly, cost for acquiring the response data is reduced. Further, compared to a case where the first search target data is included in the prompt, the number of tokens in the prompt is reduced, and thus it is possible to reduce the process time and the process load required for acquiring the response data. Compared to a case where the first search target data is included in the prompt, the number of tokens in the prompt is reduced. Accordingly, even when there is a limit on the maximum number of tokens to be processed, it would be more difficult to impose a limit on the process.

The summary information of the entire page is acquired and included in the search target data for a page including an image area where the summary information is insufficient. Accordingly, it is possible to prevent the search target data including the summary information with insufficient information from being stored in the search target storage unit 250. Accordingly, it is possible to provide a highly accurate information source to the server apparatus 500, and to enhance the accuracy of the response data to the input data.

For the page including the image area where the summary information is insufficient, page image data of the entire page and the summary information acquired from the entire page are set as search target data. By acquiring the summary information of the entire page in this manner, the information indicated by the image in the image area where the summary information is not appropriately acquired can be complemented by the information indicated by the other image area or the other text area in the page, and the accuracy of the search target data can be improved. Accordingly, it is possible to provide a highly accurate information source to the server apparatus 500, and to enhance the accuracy of the response data to the input data.

The information processing system 100 may include the information processing apparatus 200, the terminal device 300, and the terminal device 400, and the server apparatus 500 may be included in the information processing system 100 or may not be included in the information processing system 100. The terminal device 300 may also serve as the terminal device 400. In other words, the document data may be uploaded (transmitted) from the terminal device 300 to the information processing apparatus 200.

A hardware configuration of each apparatus or device included in the information processing system 100 is described below.

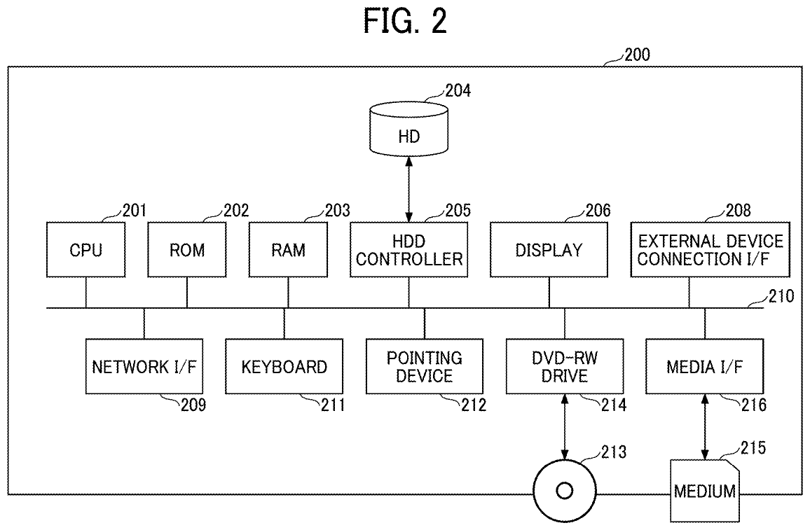

FIG. 2 is a block diagram illustrating a hardware configuration of the information processing apparatus 200 according to the first embodiment. The information processing apparatus 200 illustrated in FIG. 2, which is implemented by a computer, includes a central processing unit (CPU) 201, a read-only memory (ROM) 202, a random-access memory (RAM) 203, a hard disk (HD) 204, a hard disk drive (HDD) controller 205, a display 206, an external device connection interface (I/F) 208, a network I/F 209, a bus line 210, a keyboard 211, a pointing device 212, a digital versatile disk rewritable (DVD-RW) drive 214, and a media I/F 216.

The CPU 201 controls the overall operation of the information processing apparatus 200. The ROM 202 stores a program such as an initial program loader (IPL) used for booting the CPU 201. The RAM 203 is used as a work area for the CPU 201. The HD 204 stores various data such as a program. The HDD controller 205 controls reading and writing of various data from and to the HD 204 under control of the CPU 201. The display 206 displays various types of information, such as a cursor, a menu, a window, text, or an image. The external device connection I/F 208 is an interface that connects the information processing apparatus 200 to various external devices. Examples of the external devices in this case include, but are not limited to, a universal serial bus (USB) memory and a printer.

The network I/F 209 is an interface that enables communication of data through a communication network. The bus line 210 is, for example, an address bus or a data bus that electrically connects the components illustrated in FIG. 2, such as the CPU 201.

The keyboard 211 is an example of an input device provided with multiple keys used for inputting characters, numerical values, and various instructions. The pointing device 212 is an example of an input device that allows selection or execution of various instructions, selection of a processing target, and movement of a cursor. The DVD-RW drive 214 controls reading and writing of various data from and to a DVD-RW 213, which is an example of a removable storage medium. The removable storage medium is not limited to a DVD-RW and may be, for example, a digital versatile disc recordable (DVD-R). The media I/F 216 controls reading and writing (storing) of data from and to a storage medium 215 such as a flash memory.

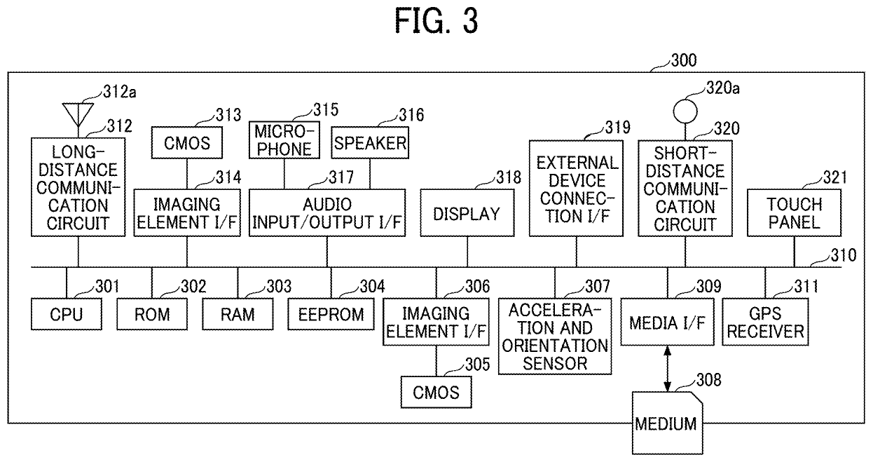

FIG. 3 is a block diagram illustrating a hardware configuration of the terminal device 300 according to the first embodiment. The terminal device 300 includes a CPU 301, ROM 302, RAM 303, electrically erasable and programmable ROM (EEPROM) 304, a complementary metal oxide semiconductor (CMOS) sensor 305, an image sensor I/F 306, an acceleration and orientation sensor 307, a media I/F 309, and a global positioning system (GPS) receiver 311.

The CPU 301 is an arithmetic processing unit, which controls the overall operation of the terminal device 300. The ROM 302 stores a program such as an IPL used for executing the CPU 301. The RAM 303 is used as a work area for the CPU 301. The EEPROM 304 reads or writes various data such as a control program for a smartphone under the control of the CPU 301. The ROM 302, RAM 303, and EEPROM 304 are examples of storage devices for the terminal device 300.

The CMOS sensor 305, which serves as a built-in imaging means, captures an object (for example, a self-image of a user) under control of the CPU 301 to obtain image data. In alternative to the CMOS sensor 605, imaging means such as a charge-coupled device (CCD) sensor may be used.

The image sensor I/F 306 is a circuit that drives the CMOS sensor 305. Examples of the acceleration and orientation sensor 307 include, but not limited to, an electromagnetic compass or gyrocompass for detecting geomagnetism and an acceleration sensor. The media I/F 309 controls the reading and writing (storing) of data to and from a storage media 308 such as a flash memory. The GPS receiver 311 receives a GPS signal from a GPS satellite.

The terminal device 300 further includes a long-range communication circuit 312, an antenna 312a for the long-range communication circuit 312, a CMOS sensor 313, an image element I/F 314, a microphone 315, a speaker 316, a audio input/output (I/O) I/F 317, a display 318, an external device connection I/F 319, a short-range communication circuit 320, an antenna 320a for the short-range communication circuit 320, and a touch panel 321.

The long-range communication circuit 312 is a circuit that communicates with other devices through a communication network. The CMOS sensor 313 serves as a built-in imaging device that captures an object under control of the CPU 301 to obtain image data. The imaging element I/F 314 is a circuit that controls driving of the CMOS sensor 313. The microphone 315 is a built-in circuit that converts sound into electrical signals. The speaker 316 is a built-in circuit that converts electrical signals into physical vibration to produce sound such as music or voice. The audio input/output I/F 317 is a circuit that inputs an audio signal from the microphone 315 or outputs an audio signal to the speaker 316 under control of the CPU 301.

The display 318 is a display that displays an image of a subject and various icons, and may be implemented by, for example, a liquid crystal display or an organic electro-luminescence (EL) display. The external device connection I/F 319 is an interface circuit that connects the terminal device 300 to various external devices. The short-range communication circuit 320 is a communication circuit in compliance with a communication protocol such as the near field communication (NFC) or Bluetooth®. The touch panel 321 is an example of an input device that allows a user to input an instruction to the terminal device 300 by touching the screen of the display 318. The display 318 is an example of a display unit included in the terminal device 300.

The hardware configuration illustrated in FIG. 3 is merely an example of the hardware configuration of the terminal device 300, and the terminal device 300 may have a hardware configuration other than that illustrated in FIG. 3. For example, the hardware configuration of the terminal device 300 may be the configuration illustrated in FIG. 2.

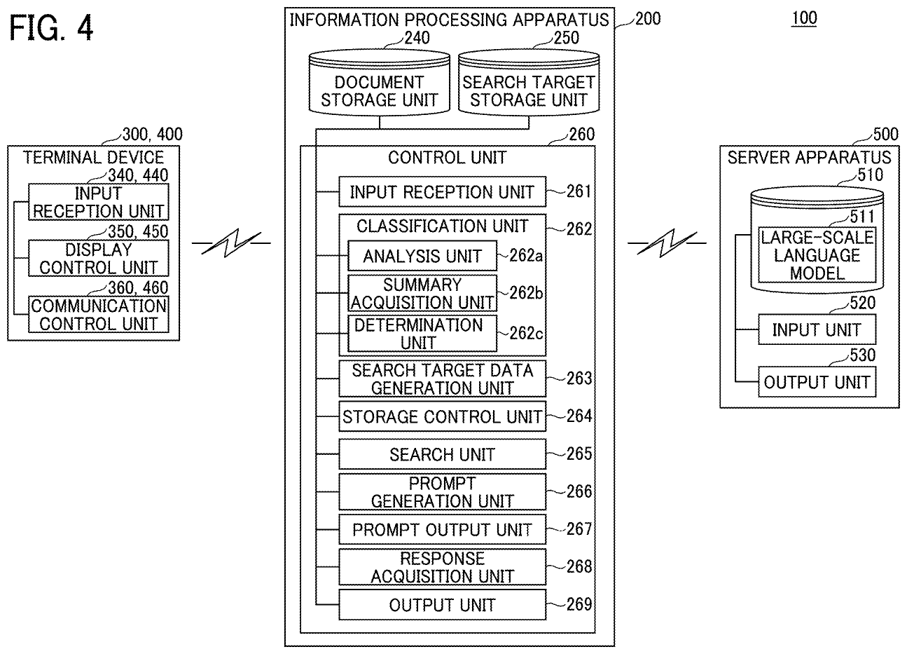

A functional configuration of each device included in the information processing system 100 is described below with reference to FIG. 4. FIG. 4 is a block diagram illustrating a functional configuration of each apparatus included in the information processing system 100 according to the first embodiment.

A functional configuration of the information processing apparatus 200 is described below. The information processing apparatus 200 includes a document storage unit 240, a search target storage unit 250, and a control unit 260.

The document storage unit 240 and the search target storage unit 250 are implemented by a storage device such as the HD 204 included in the information processing apparatus 200. The control unit 260 is implemented by the CPU 201 of the information processing apparatus 200 reading and executing instructions included in one or more programs installed in, for example, the HD 204.

The document storage unit 240 stores the document uploaded from the terminal device 400. The search target storage unit 250 stores search target data generated from the uploaded document data.

The control unit 260 controls various types of process performed by the information processing apparatus 200. The control unit 260 includes an input reception unit 261, a classification unit 262, a search target data generation unit 263, a storage control unit 264, a search unit 265, a prompt generation unit 266, a prompt output unit 267, a response acquisition unit 268, and an output unit 269.

The input reception unit 261 receives input of various data to the information processing apparatus 200. Specifically, the input reception unit 261 receives the document data uploaded from the terminal device 400. Additionally, the input reception unit 261 receives input data from the terminal device 300.

The classification unit 262 classifies pages included in the document data into the image generation target pages and the image generation non target page. Specifically, the classification unit 262 includes an analysis unit 262a, a summary acquisition unit 262b, and a determination unit 262c.

The analysis unit 262a analyzes the layout of the document data received by the input reception unit 261, and extracts the text area and the image area.

The summary acquisition unit 262b acquires the summary information corresponding to each of the text area and the image area extracted by the analysis unit 262a. The summary information is the text data.

The determination unit 262c determines, for each page included in the document data, whether the page satisfies a predetermined condition by using the summary information acquired from the image area extracted from the page. The determination unit 262c classifies the page determined to satisfy the predetermined condition as the image generation target page (first page), and classifies the page determined not to satisfy the predetermined condition as the image generation non target page (second page).

The predetermined condition is that the image area extracted from the page includes at least one of the image area in which the summary information is insufficient and the image area in which the summary information whose relevance with the summary information acquired from the text area is equal to or less than a threshold value is acquired.

For example, it is assumed that the image areas are extracted from the page. In this case, when the image areas include at least one image area in which the summary information is insufficient or at least one image area in which the summary information whose relevance with the summary information acquired from the text area is equal to or less than the threshold value is acquired, the determination unit 262c determines that the page satisfies the predetermined condition.

As described above, the determination unit 262c determines whether the image area in which the summary information is insufficient is included for each page included in the document, and determines that the page is the image generation target page when it is determined that the image area in which the summary information is insufficient is included.

The determination unit 262c acquires, for each page included in the document data, a value indicating a degree of correlation between the summary information of the image area extracted from the page and the summary information of the text area. When the page includes the image area whose value indicating the degree of correlation is equal to or less than a threshold, the determination unit 262c determines that the page is the image generation target page.

The predetermined condition may include both of the image area in which the summary information is insufficient and the image area in which the summary information whose relevance with the summary information acquired from the text area equal to or less than the threshold value is acquired. The predetermined condition may be set by, for example, a user of the terminal device 400 or an administrator of the information processing apparatus 200.

The predetermined condition may be that the image area exists in the page. In this case, the determination unit 262c sets all pages in which the image areas exist as image generation target pages, and does not acquire the summary information for each image area. When the page including the image region is set as the image generation target page and the image generation target page further includes the text area, the summary information of the text area may be acquired, and the summary information of the text area may be stored in the search target storage unit 250 in association with the summary information of the entire target page.

Accordingly, the summary information of the entire page and the summary information of the text area included in the page are stored in the search target storage unit 250, and thus the information source acquired by the search unit 265 can be made more suitable for the input data. Accordingly, it is possible to contribute to enhancement of accuracy of the response data to the input data.

The search target data generation unit 263 generates the page image data indicating the page image, which is the image of the entire page, for the page determined as the image generation target page among the pages included in the document data. The search target data generation unit 263 acquires the summary information of the entire page by the summary acquisition unit 262b for the page determined as the image generation target page, and generates the search target data in which the page image is associated with the summary information of the entire page.

The search target data generation unit 263 generates, for the page determined as the not-target page to be imaged among the pages included in the document data, search target data for each image area in which the image of the image area extracted from the page is associated with the summary information of the image area, and the search target data for each text area including the summary information of the text area extracted from the page.

The storage control unit 264 controls storage of the data in the document storage unit 240 and the search target storage unit 250. When the input reception unit 261 receives the input data transmitted from the terminal device 300, the search unit 265 retrieves the search target storage unit 250 based on the input data, and acquires the search target data as a search result.

The prompt generation unit 266 generates the prompt for requesting generation of the response to the input data received from the terminal device 300, the response being generated using, as information sources, the search target data acquired as the search result by the search unit 265. More specifically, the prompt generation unit 266 includes the input data, the search target data acquired as the search result by the search unit 265, and the text data for requesting the use of the search target data as the information source of the response data.

The prompt output unit 267 outputs the prompt generated by the prompt generation unit 266 to the server apparatus 500. The response acquisition unit 268 acquires the response data from the server apparatus 500.

The output unit 269 outputs various types of information from the information processing apparatus 200. Specifically, the output unit 269 outputs the response data acquired by the response acquisition unit 268 from the server apparatus 500 to the terminal device 300, which is a terminal device from which the input data is acquired. The output unit 269 outputs screen information for displaying classification result of the pages included in the document data by the classification unit 262 to the terminal device 400, which is the terminal from which the document is inputted. The screen information for displaying the classification result of the pages is generated by the classification unit 262.

In the example of FIG. 4, the information processing apparatus 200 includes the document storage unit 240 and the search target storage unit 250, but the configuration is not limited thereto. A part or all of each of the document storage unit 240 and the search target storage unit 250 may be provided in an external device capable of communicating with the information processing apparatus 200. In FIG. 4, the information processing apparatus 200 includes the control unit 260, but the configuration is not limited thereto. The functional units of the control unit 260 may be implemented by multiple information processing apparatuses. In other words, the functional units of the information processing apparatus 200 may be implemented by multiple information processing apparatuses.

A functional configuration of the terminal device 300 is described below. The terminal device 300 includes an input reception unit 340, a display control unit 350, and a communication control unit 360. The input reception unit 340 receives an input to the terminal device 300. The display control unit 350 controls display at the terminal device 300. The communication control unit 360 controls communication between the terminal device 300 and the information processing apparatus 200.

The input reception unit 340, the display control unit 350, and the communication control unit 360 may be implemented by a web browser included in the terminal device 300, or may be implemented by means other than the web browser.

A functional configuration of the terminal device 400 is described below. The terminal device 400 includes an input reception unit 440, a display control unit 450, and a communication control unit 460. The input reception unit 440 receives an input to the terminal device 400. The display control unit 450 controls display at the terminal device 400. The communication control unit 460 controls communication between the terminal device 400 and the information processing apparatus 200.

The input reception unit 440, the display control unit 450, and the communication control unit 460 may be implemented by a web browser included in the terminal device 400, or may be implemented by means other than the web browser.

The server apparatus 500 includes a large-scale language model storage unit 510, an input unit 520, and an output unit 530. The large-scale language model storage unit 510 stores the large-scale language model 511 for implementing the generative AI.

The large-scale language model 511 is a computer language model that is generated by executing a training process using a huge amount of unlabeled text as training data and includes an artificial neural network having a large number of parameters. The large-scale language model 511 is sufficiently trained by a method for learning a context, such as next-sentence prediction to understand a context by determining whether sentence 1 and sentence 2 are consecutive or a masked language model to understand a context by masking a word in a sentence and predicting the masked word from words that come before and after the masked word, to capture many sentence structures and meanings of human language.

The input unit 520 inputs a prompt transmitted from the information processing apparatus 200 to the large-scale language model 511. The output unit 530 outputs (transmits) output data output from the large-scale language model 511 to the information processing apparatus 200. In other words, the output unit 530 transmits the response data corresponding to the prompt, output from the large-scale language model 511 to the information processing apparatus 200.

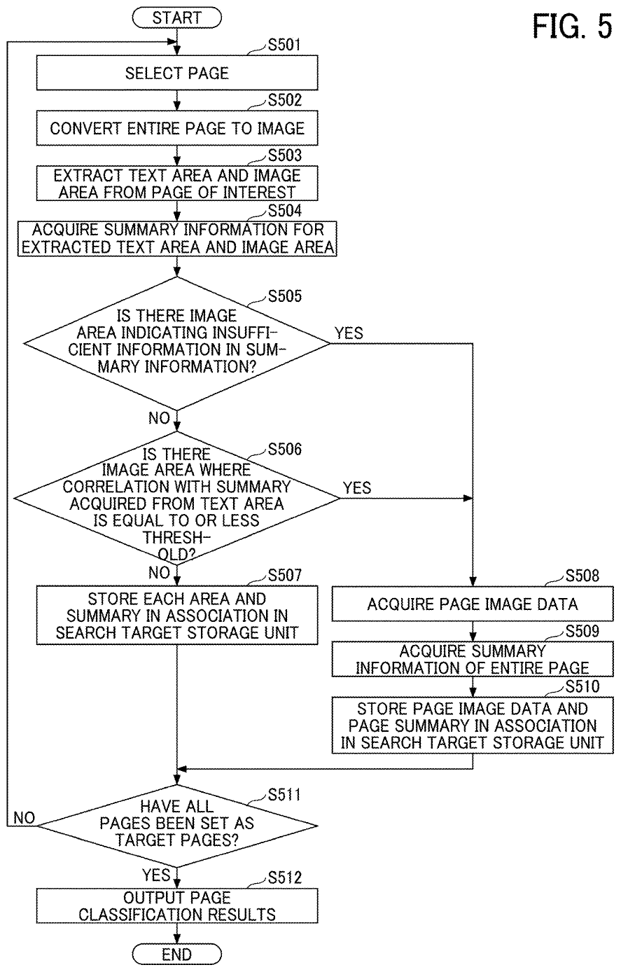

Process for generating the search target data from the document data in the information processing apparatus 200 will be described with reference to FIG. 5. FIG. 5 is a flowchart of a process performed by the information processing apparatus 200 according to the first embodiment.

The processing in FIG. 5 may be executed on the document data stored in the document storage unit 240 at predetermined intervals, or may be executed on uploaded document data at the timing when the document data is uploaded to the information processing apparatus 200.

In step S501, the control unit 260 of the information processing apparatus 200 causes the classification unit 262 to select a certain page from among pages included in the document data to be processed.

The page selected first may be the first page (first page) among the pages included in the document data. In the following description, the page being selected is referred to as a page of interest. In step S502, the control unit 260 of the information processing apparatus 200 generates the page image data indicating the page image acquired by imaging the entire page of interest.

In step S503, the control unit 260 detects the text area and the image area from the page of interest by the analysis unit 262a of the classification unit 262, and extracts the detected text area and image area.

The analysis unit 262a may extract the text area and the image area from the text data using an existing method. The analysis unit 262a may generate the prompt for requesting extraction of the text area and the image area from the document data by the prompt generation unit 266, and transmit the prompt to the server apparatus 500 by the prompt output unit 267. In this case, the analysis unit 262a acquires the extraction results of the text area and the image area by the large-scale language model 511 in the server apparatus 500. At this time, the text area and the image area may be extracted together with position information (coordinate information) indicating the respective positions in the image. When the document data does not include the image area, the analysis unit 262a may extract only the text area.

In step S504, the control unit 260 causes the summary acquisition unit 262b of the classification unit 262 to acquire summary information for each of the text areas and the image areas extracted.

Specifically, the summary acquisition unit 262b generates a prompt for requesting creation of a summary related to the text region by the prompt generating unit 266, and outputs the prompt to the server apparatus 500 by the prompt output unit 267. The summary acquisition unit 262b acquires the summary information of the text area, which is generated by the large-scale language model 511 of the server apparatus 500, from the server apparatus 500.

When the number of characters of the text data serving as the summary information is not limited, the summary acquisition unit 262b may acquire the text data included in the text area or a part of the text area as the summary information.

The summary acquisition unit 262b generates a prompt for requesting creation of a summary of the image region by the prompt generation unit 266, and outputs the prompt to the server apparatus 500 by the prompt output unit 267. The summary acquisition unit 262b acquires the summary information of the image area, which is generated by the large-scale language model 511 of the server apparatus 500, from the server apparatus 500.

For example, when the image areas are extracted from the page of interest, the summary acquisition unit 262b acquires the summary information for each image area from the server apparatus 500. Specifically, for example, it is assumed that three image areas are extracted from the page of interest. In this case, the summary acquisition unit 262b acquires the summary information for each of the three image areas.

The summary information acquired by the summary acquisition unit 262b is held in association with the text area or the image area from which the summary information is acquired.

The control unit 260 of the information processing apparatus 200 determines whether the page of interest satisfies a predetermined condition based on the determination made by the determination unit 262c of the classification unit 262.

Specifically, in step S505, the determination unit 262c determines whether there is the image area in which the acquired summary information is insufficient among the image areas extracted from the page of interest. For example, when the text data as the summary information includes character strings such as “cannot be explained” and “details are unknown,” the determination unit 262c determines that the summary information is insufficient.

In step S505, when there is the image area in which the summary information is insufficient among the image areas extracted from the page of interest (“YES” in S505), the determination unit 262c determines that the page of interest satisfies the predetermined condition, classifies the page of interest as the image generation target page, and proceeds to step S508 described below.

In step S505, when there is no image area in which the summary information is insufficient among the image areas extracted from the page of interest (“NO” in S505), in step S506, the determination unit 262c determines whether there is the summary information in which the value indicating the degree of correlation with the summary information acquired from the text area is equal to or less than a predetermined value among the summary information of the image areas.

The determination unit 262c compares, for example, the summary information acquired from a certain image area among the image regions extracted from the page of interest with the summary information of each of all the text areas extracted from the page of interest, and acquires the value indicating the degree of correlation with the summary information of each of all the text areas. The value indicating the degree of correlation may be acquired by comparing the text data with each other, using the existing technique. Alternatively, the summary information of the image area and the summary information of the text area may be input to the large-scale language model 511 and the value indicating the degree of correlation may be acquired from the large-scale language model 511.

In step S506, when there is the summary information in which the value indicating the degree of correlation with the summary information acquired from the text area is equal to or less than the predetermined value among the summary information of the image area (“YES” in S506), the determination unit 262c determines that the page of interest satisfies the predetermined condition, classifies the page of interest as the image generation target page, and the information processing apparatus 200 proceeds to step S508 described below.

In step S506, when there is no summary information in which the value indicating the degree of correlation with the summary information acquired from the text area is equal to or less than the predetermined value among the summary information of the image area (“NO” in S506), the determination unit 262c determines that the page of interest does not satisfy the predetermined condition, and classifies the page of interest as the image generation non target page.

In step S507, the search target data generation unit 263 of the information processing apparatus 200 generates the search target data for each of the text area and the image area extracted from the page of interest, and the storage control unit 264 stores the generated search target data in the search target storage unit 250.

The search target data for each area stored in the search target storage unit 250 is one chunk.

In step S505, when there is the image area in which the information of the summary information is insufficient among the image areas extracted from the page of interest, in step S508, the control unit 260 acquires the page image generated in step S502. Additionally, in step S506, when there is summary information in which the value indicating the degree of correlation with the summary information acquired from the text area is equal to or less than the predetermined value among the summary information of the image area, in step S508, the control unit 260 acquires the page image generated in step S502.

In step S509, the information processing apparatus 200 causes the summary acquisition unit 262b to acquire the summary information of the page image generated in step S508. For example, the summary acquisition unit 262b inputs the page images to the large-scale language model 511, and acquires the summary information corresponding to the page images from the large-scale language model 511.

In step S510, the search target data generation unit 263 generates the search target data in which the page image and the summary information acquired from the page image are associated with each other, and the storage control unit 264 stores the generated search target data in the search target storage unit 250. The search target data is stored in the search target storage unit 250 as one chunk by associating the page image data with the summary information acquired from the page image.

Following step S507 or step S510, in step S511, the control unit 260 of the information processing apparatus 200 determines whether all pages included in the document data have been selected as the page of interest. In other words, the control unit 260 determines whether the process from the step S502 to the step S511 has been executed for all pages included in the document data.

In step S511, when all pages are not selected as the page of interest (“NO” in S511), the control unit 260 of the information processing apparatus 200 returns to step S501. In step S511, when all pages are set as the page of interest (“YES” in S511), in step S512, the information processing apparatus 200 outputs, by the output unit 269, the screen information for displaying the classification result of the pages included in the document data by the classification unit 262 to the terminal device 400, and ends the process.

The output of the screen information for displaying the classification result of the pages may be performed at a timing different from the step S512 illustrated in FIG. 5. For example, when an operation of instructing display of the classification result is performed on the terminal device 400, the classification unit 262 may generate the screen information indicating the classification result, and the output unit 269 may output the screen information to the terminal device 400.

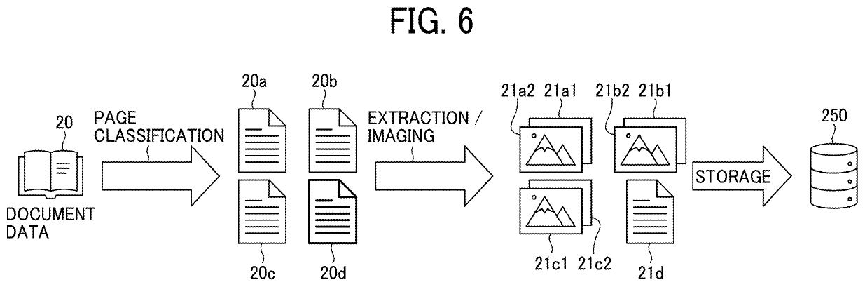

The process of the classification unit 262 will be further described with reference to FIG. 6. FIG. 6 is a diagram illustrating a process performed by the classification unit 262 according to the first embodiment.

In FIG. 6, the uploaded document data 20 includes four pages such as page 20a, page 20b, page 20c, and page 20d.

When the document data 20 is uploaded, the classification unit 262 extracts the text area and the image area from the page 20a, which is a first page, and acquires the summary information of each extracted area. The classification unit 262 determines whether the page 20a satisfies the predetermined condition. In other words, the classification unit 262 determines whether the page 20a includes the image area in which the information of the summary information is insufficient or the image area in which the summary information having the value indicating the degree of correlation with the summary information acquired from the text area is acquired, in the image areas extracted from the page 20a.

In FIG. 6, the page 20a does not satisfy the predetermined condition, and the page 20a is classified as the image generation non target page. Accordingly, the classification unit 262 generates search target data 21a1, which includes the image indicated by the image area extracted from the page 20a and the summary information thereof, and search target data 21a2, which includes the summary information of the text area extracted from the page 20a, and stores the search target data 21a1 and the search target data 21a2 in the search target storage unit 250. In other words, the information indicated by the page 20a is divided into the chunks and stored in the search target storage unit 250.

In FIG. 6, it is assumed that the page 20b and the page 20c do not satisfy the predetermined condition and are classified as the image generation non target page, similarly to the page 20a. Accordingly, from the page 20b, search target data 21b1, which includes the image indicated by the image area extracted from the page 20b and the summary information thereof, and search target data 21b2, which includes the summary information of a text area extracted from the page 20b, are generated and stored in the search target storage unit 250. From the page 20c, search target data 21c1, which includes the image indicated by the image area extracted from the page 20c and the summary information thereof, and search target data 21c2, which includes the summary information of the text area extracted from the page 20c, are generated and stored in the search target storage unit 250.

In other words, the information indicated by each of the page 20b and the page 20c is divided into the chunks and stored in the search target storage unit 250.

In FIG. 6, it is assumed that the page 20d satisfies the predetermined condition. In other words, the page 20d includes the image area in which the summary information is insufficient or the image area in which the summary information having a low relevance to the summary information acquired from the text area is acquired in the image area extracted from the page 20d.

Accordingly, the page 20d is classified as the image generation target page. The control unit 260 generates search target data 21d, which associates the page image data indicating the page image acquired by converting the entire page 20d into an image with the summary information acquired from the page image, and stores the search target data 21d in the search target storage unit 250. In other words, the information indicated by the page 20d is stored in the search target storage unit 250 as one chunk.

As described above, only for the page satisfying the predetermined condition among the pages included in the document data, the information indicated by the page is set as one chunk. For the page that does not satisfy the predetermined condition among pages included in the document data, the information in each area included in the page is set as one chunk. The information in each area is the information indicated by the text data in the text area or the information indicated by the image in the image area.

When the data in each area included in the page is one chunk, the amount of the information of one chunk is smaller than the amount when the information indicated by the entire page is one chunk.

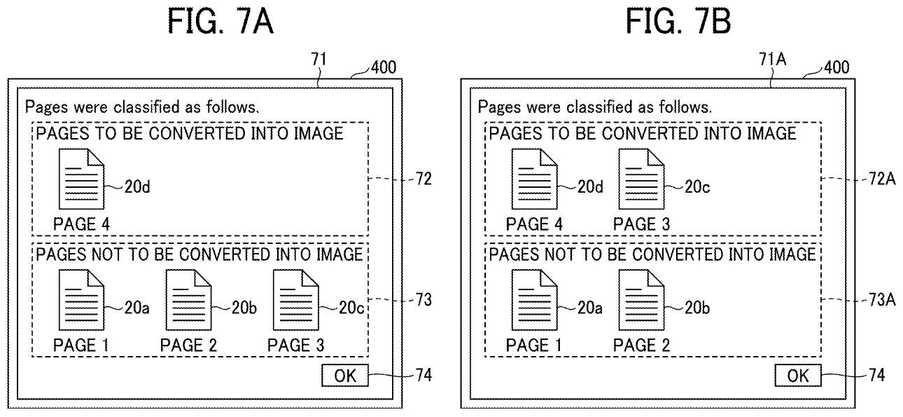

A display of the classification result by the classification unit 262 will be described with reference to FIG. 7. FIG. 7A and FIG. 7B are diagrams illustrating a screen displayed by the terminal device 400 according to the first embodiment. A screen 71 illustrated in FIG. 7A is the screen on which a result of classifying the four pages of page 20a, page 20b, page 20c, and page 20d included in the document data 20, the image generation target page, and the image generation non target page is displayed in the terminal device 400.

The screen 71 includes display areas 72 and 73 and an operation button 74. Information indicating the page 20d that is the image generation target is displayed in the display area 72, and information indicating the pages 20a, the page 20b, and the page 20c that are not image generation non target is displayed in the display area 73.

In FIG. 7A, the thumbnail image of page 20d is displayed in the display area 72, and the thumbnail images of page 20a, page 20b, and page 20c are displayed in the display area 73. The information indicating the image generation target page displayed in the display area 72 and the information indicating the image generation non target page displayed in the display area 73 are not limited to the thumbnail image. In each of the display areas 72,73, for example, information indicating the number of pages in the document data may be displayed.

The operation button 74 is an operation button for storing the search target data based on the classification result displayed in the display areas 72 and 73 in the search target storage unit 250.

The screen 71 receives editing of the classification result by the classification unit 262. In other words, on the screen 71, the classification result of the pages by the classification unit 262 may be edited in accordance with the operation of the user of the terminal device 400.

Specifically, the user of the terminal device 400 may reclassify the page classified as the image generation target page as the image generation non target page by moving the thumbnail image displayed in the display area 72 of the screen 71 into the display area 73. The user of the terminal device 400 can reclassify the pages classified as the image generation non target page into the image generation target page by moving the thumbnail images displayed in the display area 73 into the display area 72.

In a screen 71A illustrated in FIG. 7B, the thumbnail image of a page 20c and a thumbnail image of the page 20d are displayed in the display area 72A, and a thumbnail image of the page 20a and a thumbnail image of the page 20b are displayed in the display area 73A. Accordingly, it indicates that, in the screen 71A, the user of the terminal device 400 moved the thumbnail image of the page 20c displayed in the display area 73 into the display area 72 and reclassifies the page 20c from the image generation non target page to be imaged to the image generation target page.

When the operation button 74 is operated on the screen 71A, the information processing apparatus 200 generates the page image information indicating the page image of the page 20c, and associates the page image information with summary information acquired from the page image of the page 20c, thereby acquiring search target data including the information of the page 20c. At this time, when the search target storage unit 250 stores the search target data for each area extracted from the page 20c, the storage control unit 264 may delete the search target data.

The user of the terminal device 400 who has uploaded the document data can confirm the classification result of the page by the classification unit 262. The user of the terminal device 400 can edit the result of the classification of the pages by the classification unit 262.

Accordingly, the user can re-classify the pages when the classification result by the classification unit 262 is incorrect, or when the classification result by the classification unit 262 is different from the intention of the user of the terminal device 400.

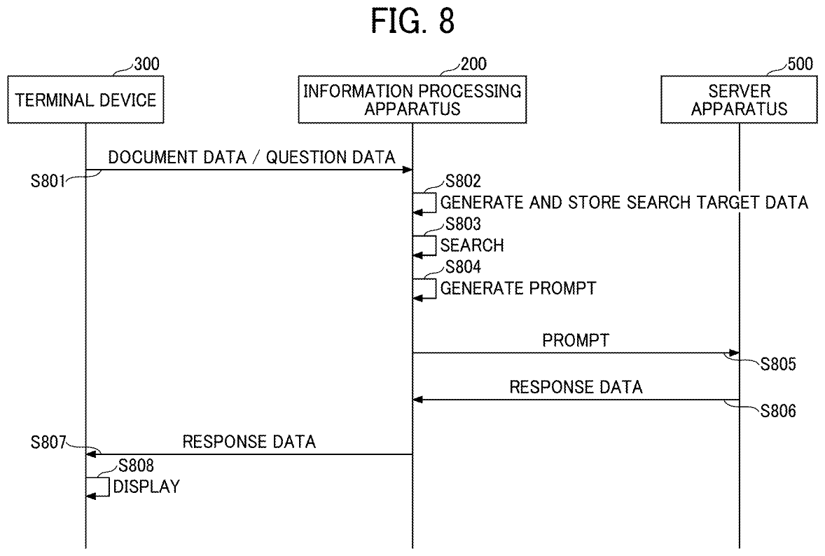

An operation of the information processing system 100 will be described with reference to FIG. 8. FIG. 8 is a sequence diagram illustrating an operation performed by the information processing system 100 according to the first embodiment. FIG. 8 illustrates the operation of the information processing system 100 in a case where the terminal device 300 also serves as the terminal device 400 and the process illustrated in FIG. 5 is executed at the timing when the document data is uploaded. The document data is assumed to be transmitted from the terminal device 300 to the information processing apparatus 200 together with the input data.

In step S801, in the information processing system 100, when the terminal device 300 receives, via the input reception unit 340, input data input by the user and a designation of the document data, the terminal device 300 transmits the input data and the document data to the information processing apparatus 200 via the communication control unit 360.

In step S802, when the control unit 260 of the information processing apparatus 200 receives the inputs of the input data and the text data by the input reception unit 261, the control unit 260 generates the search target data and stores the search target data in the search target storage unit 250. To be specific, in step S802, the control unit 260 executes the process illustrated in FIG. 5. At this time, the document data is stored in the document storage unit 240 in association with the generated search target data.

In step S803, the information processing apparatus 200 causes the search unit 265 to search the search target storage unit 250 using the input data as a search query and acquire a search result.

The information processing apparatus 200 may hold interaction history information indicating a history of interactions between the user of the terminal device 300 and the large-scale language model 511.

In this case, the information processing apparatus 200 determines whether the interaction history information is held in the information processing apparatus 200 in step S802, and acquires the interaction history information when the interaction history information is held. The information processing apparatus 200 generates a prompt for requesting generation of the search query for searching the search target storage unit 250 based on the input data and the interaction history information by the prompt generation unit 266, and outputs the prompt to the server apparatus 500 by the prompt output unit 267. When the search unit 265 of the information processing apparatus 200 acquires the search query for searching the search target storage unit 250 from the server apparatus 500, the search target storage unit 250 is searched by the search query, and the search result is acquired.

In step S804, the information processing apparatus 200 generates, by the prompt generation unit 266, the prompt for requesting generation of response data to the input data, using the search target data acquired as the search result by the search unit 265 as a source.

In step S805, the information processing apparatus 200 outputs the prompt to the server apparatus 500. In step S806, the response acquisition unit 268 acquires a response from the server apparatus 500. In step S807, the information processing apparatus 200 outputs the response to the terminal device 300 by the output unit 269.

In step S808, when the terminal device 300 acquires the response data to the input data from the information processing apparatus 200, the display control unit 350 displays the response on the display 318.

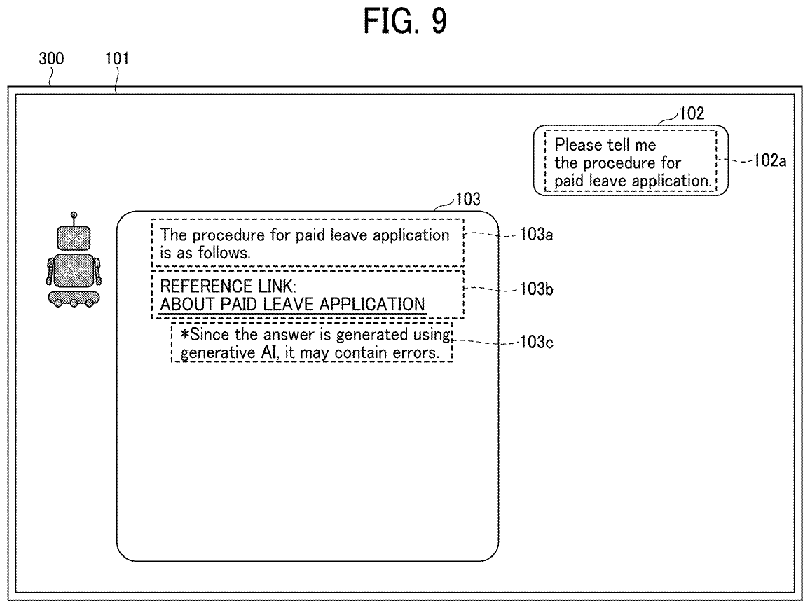

A display example of the terminal device 300 will be described with reference to FIG. 9. FIG. 9 is a diagram illustrating another screen displayed by the terminal device 300 according to the first embodiment. A screen 101 illustrated in FIG. 9 is an example of a screen displayed on the terminal device 300 in the step S808 illustrated in FIG. 8.

The screen 101 includes display areas 102 and 103. The display area 102 displays information input by the user of the terminal device 300.

The display area 103 includes display areas 103a, 103b, and 103c. The display area 103a displays the text data as the response data from the information processing system 100. In the display area 103b, a link indicating a storage destination of the document data that is the source of the response data is displayed. In the display area 103c, a message for notifying the user of the terminal device 300 that the response data has been generated by the generation AI is displayed.

Accordingly, it is possible to request the large-scale language model 511 to generate the response data using an information source appropriate for the input data, and it is possible to enhance the accuracy of the response data for the input data.

When the summary information that is the information source of the response data is the summary information acquired from the image area, the image of the image area associated with the summary information may be displayed together with the response data. As described above, by displaying the image from which the summary information as the source of information is acquired together with the response data, it is possible to present information with higher accuracy to the user of the terminal device 300.

### Second Embodiment

A second embodiment will be described with reference to the drawings. The second embodiment is different from the first embodiment in that the document data is the document data having a structured format. In the following description of the second embodiment, differences from the first embodiment are described. The same reference numerals are given to the same or corresponding functions or configurations as those of the first embodiment, and redundant descriptions thereof are omitted or simplified appropriately.

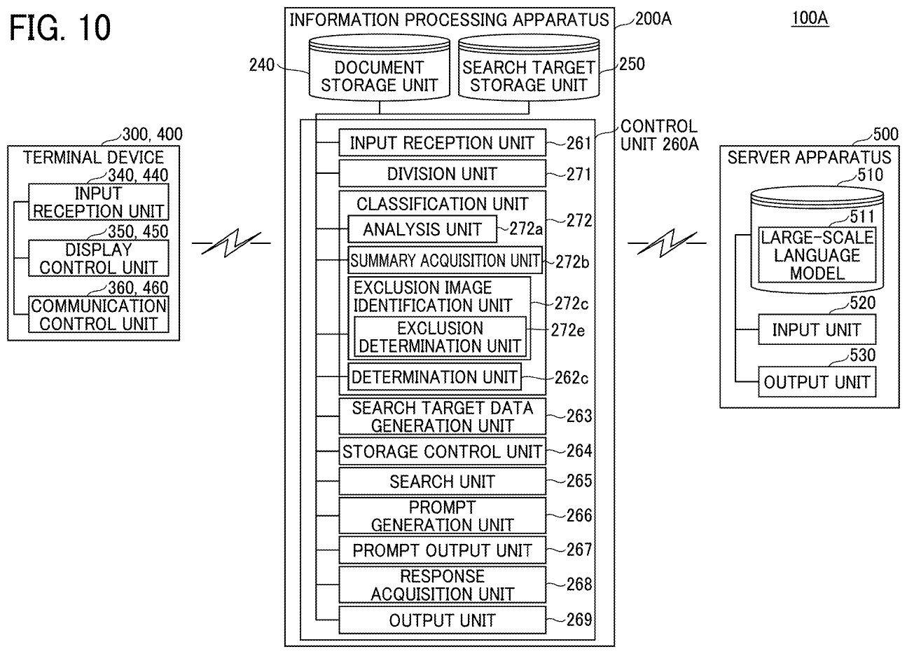

FIG. 10 is a block diagram illustrating a functional configuration of each apparatus included in the information processing system according to the second embodiment.

The information processing system 100A includes an information processing apparatus 200A, the terminal device 300, and the terminal device 400. The information processing apparatus 200A includes the document storage unit 240, the search target storage unit 250, and a control unit 260A.

The information processing apparatus 200 includes the input reception unit 261, a division unit 271, a classification unit 272, the search target data generation unit 263, the storage control unit 264, the search unit 265, the prompt generation unit 266, the prompt output unit 267, the response acquisition unit 268, and an output unit 269.

The division unit 271 divides the document data received by the input reception unit 261 into predetermined range data.

The predetermined range data can be set in advance. The predetermined range data is, for example, data acquired by dividing the document data having the structured format into predetermined units such as chapters, sections, and sections.

When one unit of the data is long in the case where, for example, a paragraph, a chapter, a clause, or a section is used as a unit, the predetermined range data can be further divided into pages or a predetermined upper limit.

The case where the one unit of data is long is a case where a plurality of pages are included in one predetermined range when the one unit of the data is equivalent to the printed matter, or a case where a very long image is generated when a web page is rendered.

The classification unit 272 classifies the predetermined range data into predetermined range data to be imaged and predetermined range data not to be imaged. In the following description, the predetermined range data to be imaged is referred to as target data, and the predetermined range data not to be imaged is referred to as non-target data. The target data is first predetermined range data, and the non-target data is second predetermined range data.

Specifically, the classification unit 272 includes an analysis unit 272a, a summary acquisition unit 272b, an exclusion image identification unit 272c, and the determination unit 262c.

The analysis unit 272a analyzes the predetermined range data based on a description format of the document data, and extracts the text data and the image data from the predetermined range data.

The summary acquisition unit 272b acquires the summary information corresponding to each of the text data and image data extracted by the analysis unit 272a. The summary information may be the text data or the image data.

The exclusion image identification unit 272c understands the content of the image data indicated by the image data extracted by the analysis unit 272a. In other words, the exclusion image identification unit 272c identifies an image for which the summary information does not need to be acquired among the images indicated by the image date extracted by the analysis unit 272a, and excludes the identified image from the images for which the summary information is to be acquired.

Specifically, the exclusion image identification unit 272c includes an exclusion determination unit 272e. The exclusion determination unit 272e determines whether there is an image satisfying an exclusion condition among the images. The exclusion image identification unit 272c excludes an image determined to satisfy the exclusion condition by the exclusion determination unit 272e from the images of the target for acquiring the summary information.

The exclusion condition includes, for example, at least one of a condition that the size of the extracted image data is smaller than a predetermined size and a condition that the extracted image data is an image indicating a figure designated in advance. The exclusion determination unit 272e may hold the exclusion condition.

The figure designated in advance includes, for example, an icon, a pictogram, and a thumbnail image. The figure designated in advance may be a general figure or a figure that is not need to be explained in detail in the process of interpreting and analyzing the content indicated by the predetermined range data including the figure.

By excluding images satisfying the exclusion condition from the target of images for which the summary information is to be acquired, it is possible to prevent the summary information of unnecessary images that do not contribute to interpretation of the content of the predetermined range data from being included in the search target data. Accordingly, the number of tokens of the prompt required for acquiring the response data is reduced.

Additionally, since the summary information of an unnecessary image does not include the search target data, it is possible to prevent unnecessary information from being included in a prompt input to the large-scale language model 511, and it is possible to enhance the accuracy of the answer from the large-scale language model 511.

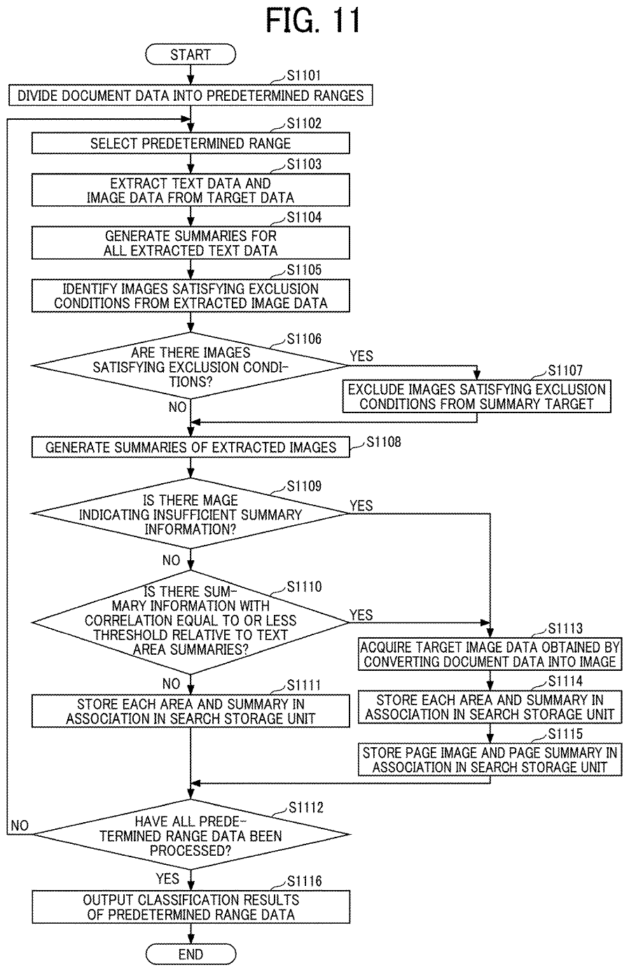

A process of generating the search target data from the document data in the information processing apparatus 200A will be described with reference to FIG. 11. FIG. 11 is a flowchart of a process performed by the information processing apparatus 200A according to the second embodiment.

In step S1101, the control unit 260A of the information processing apparatus 200A divides the input document data into the predetermined range data by the division unit 271.

When variation in a data amount for each predetermined range data is equal to or greater than a predetermined amount, the division unit 271 may, for example, set a threshold value for the data amount and divide the document data such that the document data has an amount close to the threshold value. The data amount for each predetermined range data includes a data capacity, a data size, and a text amount.

The division unit 271 may render (image) the document data as the page image and divide data of one page as the predetermined range data. The division unit 271 renders content of one chapter and divide data that falls within a limit value that may be input to, for example, a large-scale language model 511 or a visual language model as the predetermined range data.

In step S1102, the control unit 260A selects the predetermined range data to be processed by the classification unit 272. In the following description, the predetermined range data selected in step S1102 is referred to as the data of interest.

In step S1103, the control unit 260A analyzes the data of interest based on the analysis result of the analysis unit 272a of the classification unit 272, and extracts the image data and the text data from the data of interest. Specifically, the analysis unit 272a decomposes the predetermined range data according to the structured format of the document data to extract the text data and the image data.

In step S1104, the classification unit 272 generates the summary information of the text data extracted in step S1103 by the summary acquisition unit 272b. The text data extracted from the predetermined range data may be used as the summary information.

In step S1105, at the classification unit 272, the exclusion image identification unit 272c specifies the image satisfying the exclusion condition from among the images indicated by the extracted image date.

Specifically, the exclusion image identification unit 272c causes the exclusion determination unit 272e to determine, for each image indicated by all of the image data extracted in step S1103, whether the image satisfies the exclusion condition.

In step S1106, the exclusion image identification unit 272c determines whether there is an image satisfying the exclusion condition.

When there is an image satisfying the exclusion condition in step S1106 (“YES” in S1106), the exclusion image identification unit 272c excludes the image satisfying the exclusion condition from the target for which the summary information is generated in step S1107, and the process proceeds to step S1108 to be described below.

When there is no image satisfying the exclusion condition in step S1106 (“NO” in S1106), in step S1108, the classification unit 272 causes the summary acquisition unit 272b to generate the summary information of the image indicated by the image data based on the image data extracted from the predetermined range data. In other words, in step S1108, the summary information of the image that does not satisfy the exclusion condition is generated and acquired.

In step S1109, the classification unit 272 causes the determination unit 262c to determine whether there is image data for which the acquired summary information is insufficient among the image data extracted from the data of interest.

In step S1109, when it is determined that there is no image data with insufficient summary information (“NO” in S1109), in step S1110, the determination unit 262c determines whether there is summary information of the image, the summary information having the value indicating the degree of correlation with the summary information acquired from the text data, the value being equal to or less than a predetermined value.

In step S1110, when there is summary information having the value indicating the degree of correlation with the summary information acquired from the text data is equal to or less than the predetermined value (“YES” in S1110), the determination unit 262c determines that the data of interest satisfies the predetermined condition, and classifies the data of interest as the data of interest to be the image generation target page, and the information processing apparatus 200A proceeds to step S1112 described below.

In step S1110, when there is no summary information whose value indicating the degree of correlation with the summary information acquired from the text data is equal to or less than the predetermined value (“NO” in S1110), the determination unit 262c determines that the data of interest does not satisfy the predetermined condition, and classifies the data of interest as the image generation non target page.

In step S1111, the information processing apparatus 200A generates, using the search target data generation unit 263, the search target data for each of the text data and the image data extracted from the data of interest, and stores, using the storage control unit 264, the generated search target data in the search target storage unit 250.

In step S1109, when there is image information in which the summary information is insufficient among the image data extracted from the data of interest (“YES” in S1109), and in step S1110, when there is summary information in which the value indicating the degree of correlation with the summary information acquired from the text data among the summary information of the image data is equal to or less than the predetermined value (“YES” in S1110), the control unit 260A generates the image data indicating a predetermined range image acquired by imaging the predetermined range data.

In step S1113, the information processing apparatus 200A causes the summary acquisition unit 262b to acquire summary information of the predetermined range image. Specifically, for example, the summary acquisition unit 272b inputs the image data indicating the predetermined range image to the large-scale language model 511, and acquires the summary information corresponding to the predetermined range image from the large-scale language model 511.

In step S1114, the information processing apparatus 200A causes the search target data generation unit 263 to generate predetermined range data in which the predetermined range data and the summary information acquired from the predetermined range image are associated with each other, and the storage control unit 264 stores the generated search target data in the search target storage unit 250. The search target data is stored in the search target storage unit 250 as one chunk by associating the predetermined range data with the summary information acquired from the predetermined range image. In step S1115, the storage control unit 264 stores the page image and the summary information in association in the search target storage unit 250.

After step S1111 or step S1115, in step S1112, the control unit 260A determines whether all the predetermined range data divided in step S1101 have been selected as data of interest. In other words, the control unit 260A determines whether the process from step S1102 to S1111 or step S1115 has been executed for all the predetermined range data included in the document data.

In step S1112, when all of the divided predetermined range data have not been selected as the data of interest (“NO” in S1112), the control unit 260A returns to step S1102. In step S1112, when all the divided predetermined range data are selected as the page of interest (“YES” in S1112), in step S1116, the control unit 260A causes the output unit 269 to output the screen information for displaying the classification result of the pages included in the document data by the classification unit 262 to the terminal device 400, and ends the process.

As described above, as in the first embodiment, it is possible to request the large-scale language model 511 to generate the response data using an information source appropriate for the input data, and it is possible to enhance the accuracy of the response data for the input data.

### Third Embodiment

A third embodiment will be described with reference to the drawings. The third embodiment is different from the second embodiment in that the information processing apparatus 200B includes the large-scale language model 511. Therefore, in the following description of the third embodiment, differences from the second embodiment are described. In the following description of the third embodiment, the same reference numerals are given to the same or corresponding functions or configurations as those of the second embodiment, and redundant descriptions thereof are omitted or simplified appropriately.

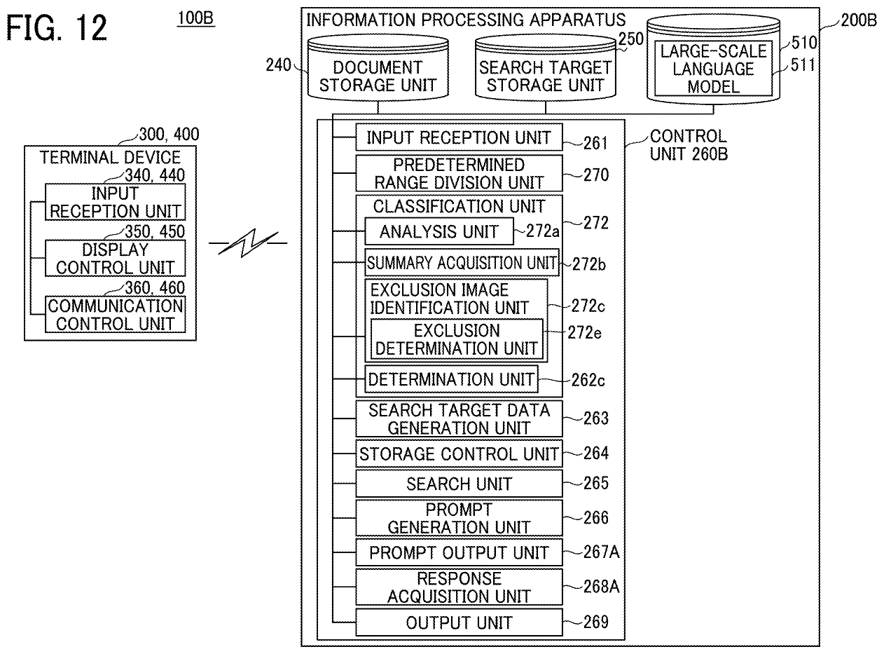

FIG. 12 is a block diagram illustrating a functional configuration of each apparatus included in the information processing system 100 according to the third embodiment.

The information processing system 100B includes an information processing apparatus 200B, the terminal device 300, and the terminal device 400. The information processing apparatus 200B includes the document storage unit 240, the search target storage unit 250, the large-scale language model storage unit 510, and a control unit 260B.

The control unit 260B includes the input reception unit 261, the division unit 271, the classification unit 272, the search target data generation unit 263, the storage control unit 264, the search unit 265, the prompt generation unit 266, a prompt output unit 267A, a response acquisition unit 268A, and the output unit 269.

The prompt output unit 267A outputs the prompt generated by the prompt generation unit 266 to the large-scale language model 511 of the large-scale language model storage unit 510. The response acquisition unit 268A acquires the response data output by the large-scale language model 511.

As described above, by providing the large-scale language model 511 in the information processing apparatus 200B, the information processing apparatus 200B acquires the response data of the large-scale language model 511 without communicating with an external device. Accordingly, the load of the communication of the information processing apparatus 200B is reduced.

Further, since the input data input to the information processing apparatus 200B is not transmitted to the outside of the information processing system 100B, the confidentiality of the input data and the response data is maintained.

The functionality of the elements disclosed herein may be implemented using circuitry or processing circuitry which includes general purpose processors, special purpose processors, integrated circuits, application-specific integrated circuits (ASICs), a digital signal processors (DSPs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The group of apparatuses or devices described in the above-described embodiments is merely one example of multiple computing environments for implementing the embodiments disclosed herein.

In some embodiments, the information processing apparatus 200 includes multiple computing devices, such as a server cluster. The multiple computing devices are configured to communicate with each other through any type of communication links, including a network or a shared memory, to perform the processes disclosed herein. Similarly, the information processing apparatus 200 may include multiple computing devices that are configured to communicate with each other.

Further, the information processing apparatus 200 can be configured to share the disclosed processes in various combinations. For example, the processes performed by one or more predetermined units may be performed by any one of the computing devices operating as the information processing apparatus 200. Similarly, the functions performed by one or more predetermined units may be performed by any one of the computing devices operating as the information processing apparatus 200. The functional elements of the information processing apparatus 200 may be integrated into a single server apparatus or distributed among a plurality of apparatuses.

The information processing apparatus 200 may be any apparatus having a communication function. The information processing apparatus 200 may be, for example, an output device such as a projector (PJ), an interactive whiteboard (IWB; an electronic whiteboard having a blackboard function enabling mutual communication), or digital signage, or may be a head-up display (HUD), an industrial machine, an imaging device, a sound collecting device, a medical device, a networked home appliance, an automobile (connected car), a laptop personal computer (PC), a mobile phone, a smartphone, a tablet terminal, a game console, a personal digital assistant (PDA), a digital camera, a wearable PC, or a desktop PC.

Aspects of the present disclosure are, for example, as follows.

### Aspect 1

An information processing apparatus includes an input reception unit that receives input data input from a terminal device, a prompt output unit that outputs, to a large-scale language model, a prompt requesting generation of output data corresponding to the input data, and an output unit that outputs, to the terminal device, a response data to the prompt from the large-scale language model. The prompt is a prompt requesting generation of response data by searching a storage unit with the input data and using a search result as an information source, the storage unit storing first search target data generated for each item of predetermined range data, among predetermined range data included in document data, that is classified as first predetermined range data satisfying a predetermined condition and second search target data generated for each item of data extracted from predetermined range data, among predetermined range data included in the document data, that is classified as second predetermined range data not satisfying the predetermined condition.

### Aspect 2

In the information processing apparatus according to Aspect 1, the document data is document data described in each predetermined unit according to a predetermined structure, and the predetermined range data is data acquired by dividing the document data into the predetermined units.

### Aspect 3

The information processing apparatus according to Aspect 1 or 2 further includes a classification unit that classifies predetermined range data included in the document data into the first predetermined range data when it is determined that the predetermined range data satisfies the predetermined condition, and classifies the predetermined range data into the second predetermined range data when it is determined that the predetermined range data does not satisfy the predetermined condition. The classification unit includes an analysis unit that extracts image data and text data from the predetermined range data included in the document data, a summary acquisition unit that acquires summary information of an image indicated by the image data and summary information of the text data, and a determination unit that determines whether the predetermined range data included in the document data satisfies the predetermined condition by using the summary information of the image. The predetermined condition is that the image data extracted from the predetermined range data included in the document data includes at least one of the image data in which information of the summary information is insufficient or the image data in which the summary information having a relevance to the summary information acquired from a text area equal to or less than a threshold value is acquired.

### Aspect 4

The information processing apparatus according to Aspect 3 further includes a search target data generation unit that generates the first search target data and the second search target data, and a storage control unit that stores the first search target data and the second search target data in the storage unit. The search target data generation unit generates, when the predetermined range data included in the document data is classified as the first predetermined range data, the first search target data in which the image data indicating the image of the predetermined range data and the summary information generated from the predetermined range data are associated with each other. When the predetermined range data included in the document data is classified into the second predetermined range data, the search target data generation unit generates the second search target data including the summary information acquired from the image data and the text data for each of the image data and the text data extracted from the predetermined range data.

### Aspect 5

In the information processing apparatus according to Aspect 4, the analysis unit analyzes the predetermined structure in the document data to extract the text data and the image data from the document data.

### Aspect 6

The information processing apparatus according to Aspect 3 or 4 further includes an exclusion image specification unit that specifies an exclusion image to be excluded from a target of acquisition of the summary information by the summary acquisition unit, among images indicated by image data extracted from the predetermined range data. The summary acquisition unit acquires the summary information for images excluding the exclusion image among images indicated by the image data extracted from the predetermined range data.

### Aspect 7

In the information processing apparatus according to Aspect 6, the exclusion image specification unit includes an exclusion determination unit that determines whether there is an image satisfying an exclusion condition among the images indicated by the image data extracted from the predetermined range data, and the exclusion image specification unit specifies the exclusion image satisfying the exclusion condition.

### Aspect 8

In the information processing apparatus according to Aspect 7, the exclusion condition includes at least one of a condition that a size of the image data is equal to or smaller than a predetermined size and a condition that the image data is an image indicating a figure designated in advance.

### Aspect 9

In the information processing apparatus according to Aspect 7 or 8, the exclusion determination unit determines whether there is an image satisfying the exclusion condition using at least one of a method of determining whether there is an image satisfying the exclusion condition by performing rendering on the image of the predetermined range data and a method of extracting the image satisfying the exclusion condition from the predetermined range data.

### Aspect 10

In the information processing apparatus according to any one of Aspects 7 to 9, the exclusion determination unit outputs a prompt for requesting a large-scale language model to determine whether an image indicated by image data extracted from the predetermined range data satisfies the exclusion condition to acquire a result of the determination as to whether the exclusion condition is satisfied, as response data from the large-scale language model.

### Aspect 11

In the information processing apparatus according to any one of Aspects 7 to 10, the predetermined range data is data processed as one page when the document data is output as a printed matter.

### Aspect 12

The information processing apparatus according to Aspect 11 further includes a classification unit that classifies a page included in the input document data as the first predetermined range data when the page is determined to satisfy the predetermined condition, and classifies the page as the second predetermined range data when the first predetermined range data included in the document data is determined not to satisfy the predetermined condition. The classification unit includes an analysis unit extracts an image area and a text area from predetermined range data included in the document data, a summary acquisition unit that acquires summary information of the image area and the summary information of the text area, and a determination unit that determines whether the predetermined range data included in the document data satisfies the predetermined condition by using the summary information of the image area. The predetermined condition is that the image area extracted from the predetermined range data included in the document data includes at least one of the image area in which information of the summary information is insufficient or the image area in which the summary information having a relevance to the summary information acquired from the text area equal to or less than a threshold value is acquired.

### Aspect 13

The information processing apparatus according to Aspect 11 or 12 further includes a search target data generation unit that generates the first search target data and the second search target data, and a storage control unit that stores the first search target data and the second search target data in the storage unit. The search target data generation unit generates, when a page included in the document data is classified into the first predetermined range data, the first search target data in which page image data indicating a page image that is an image of an entire page of the page and the summary information of the entire page are associated with each other, and when a page included in the document data is classified into the second predetermined range data, the second search target data including the summary information acquired from the image area and the text area for each of the image area and the text area extracted from the page.

### Aspect 14

In the information processing apparatus according to Aspect 3, the classification unit generates screen information for displaying a result of classifying predetermined range data included in the document data into the first predetermined range data or the second predetermined range data, and the output unit outputs the screen information to a terminal device as an input source of the document data.

### Aspect 15

In the information processing apparatus according to Aspect 3, the screen displayed based on the screen information is a screen for receiving editing of the classified result, and when the editing is performed on the result of the classification of the pages included in the document data on the screen, the search target data generation unit generates the first search target data or the second search target data in accordance with the result of the classification of the pages included in the document data after the editing.

### Aspect 16

An information processing method performed by an information processing apparatus, includes receiving input data input from a terminal device, outputting, to a large-scale language model, a prompt requesting generation of output data corresponding to the input data, and outputting, to the terminal device, a response data to the prompt from the large-scale language model. The prompt is a prompt requesting generation of response data by searching a storage unit with the input data and using a search result as an information source, the storage unit storing first search target data generated for each item of predetermined range data, among predetermined range data included in document data, that is classified as first predetermined range data satisfying a predetermined condition and second search target data generated for each item of data extracted from predetermined range data, among predetermined range data included in the document data, that is classified as second predetermined range data not satisfying the predetermined condition.

### Aspect 17

A program to be executed by an information processing apparatus, the program including receiving input data input from a terminal device, outputting, to a large-scale language model, a prompt requesting generation of output data corresponding to the input data, and outputting, to the terminal device, a response data to the prompt from the large-scale language model. The prompt is a prompt requesting generation of response data by searching a storage unit with the input data and using a search result as an information source, the storage unit storing first search target data generated for each item of predetermined range data, among predetermined range data included in document data, that is classified as first predetermined range data satisfying a predetermined condition and second search target data generated for each item of data extracted from predetermined range data, among predetermined range data included in the document data, that is classified as second predetermined range data not satisfying the predetermined condition.

### Aspect 18

An information processing system includes an information processing apparatus and a terminal device that communicates with the information processing apparatus via a network. The information processing apparatus includes an input reception unit that receives input data input from a terminal device, a prompt output unit that outputs, to a large-scale language model, a prompt requesting generation of output data corresponding to the input data, and an output unit that outputs, to the terminal device, a response data to the prompt from the large-scale language model. The prompt is a prompt requesting generation of response data by searching a storage unit with the input data and using a search result as an information source, the storage unit storing first search target data generated for each item of predetermined range data, among predetermined range data included in document data, that is classified as first predetermined range data satisfying a predetermined condition and second search target data generated for each item of data extracted from predetermined range data, among predetermined range data included in the document data, that is classified as second predetermined range data not satisfying the predetermined condition. The terminal device includes a display control unit that causes a display unit to display the response received from the information processing apparatus.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing apparatus comprising circuitry configured to:
receive input data input from a terminal device,
output, to a large-scale language model, a prompt requesting generation of output data corresponding to the input data, and
output, to the terminal device, response data to the prompt received from the large-scale language model,
wherein the prompt is a prompt requesting generation of the response data by searching a memory with the input data and using a search result as an information source,
the memory storing first search target data and second search target data,
the first search target data being generated for each of first predetermined range data satisfying a predetermined condition, among predetermined range data included in document data,
the second search target data being generated for each of data extracted from second predetermined range data not satisfying the predetermined condition, among the predetermined range data included in the document data.

2. The information processing apparatus according to claim 1,
wherein the document data is described for each of predetermined units according to a predetermined structure, and
wherein the predetermined range data is acquired by dividing the document data into the predetermined units.

3. The information processing apparatus according to claim 2, wherein the circuitry is further configured to:
extract image data and text data from the predetermined range data included in the document data;
acquire summary information of an image indicated by the image data and summary information of the text data; and
determine whether the predetermined range data included in the document data satisfies the predetermined condition based on the summary information of the image;
classify the predetermined range data into the first predetermined range data in a case where the predetermined range data satisfies the predetermined condition; and
classify the predetermined range data into the second predetermined range data in a case where the predetermined range data does not satisfy the predetermined condition;
wherein the predetermined condition is a condition that the image data extracted from the predetermined range data included in the document data includes at least one of image data having insufficient summary information or image data having summary information having a relevance equal to or less than a threshold relative to summary information acquired from a text area.

4. The information processing apparatus according to claim 3, wherein the circuitry is configured to:
in the case where the predetermined range data included in the document data is classified as the first predetermined range data, generate and store the first search target data, the first search target data including the image data indicating the image of the predetermined range data and the summary information generated from the predetermined range data that are associated; and
in the case where the predetermined range data included in the document data is classified into the second predetermined range data, generate and store the second search target data, the second search target data including the summary information acquired from the image data and the text data for each of the image data and the text data extracted from the predetermined range data.

5. The information processing apparatus according to claim 3,
wherein the circuitry is further configured to analyze the predetermined structure in the document data to extract the text data and the image data from the document data.

6. The information processing apparatus according to claim 3, wherein the circuitry is further configured to:
specify an exclusion image to be excluded from a target of acquisition of the summary information, among the images indicated by the image data extracted from the predetermined range data; and
acquire the summary information for the images excluding the exclusion image among the images indicated by the image data extracted from the predetermined range data.

7. The information processing apparatus according to claim 6, wherein the circuitry is further configured to:
determine whether there is an image satisfying an exclusion condition among the images indicated by the image data extracted from the predetermined range data; and
specify the exclusion image satisfying the exclusion condition.

8. The information processing apparatus according to claim 7,
wherein the exclusion condition includes at least one of a condition that a size of the image data is equal to or smaller than a predetermined size and a condition that the image data is an image indicating a figure designated in advance.

9. The information processing apparatus according to claim 7,
wherein the circuitry is further configured to determine whether there is an image satisfying the exclusion condition using at least one of a method of determining whether there is an image satisfying the exclusion condition by performing rendering on the image of the predetermined range data and a method of extracting the image satisfying the exclusion condition from the predetermined range data.

10. The information processing apparatus according to claim 7,
wherein the circuitry is further configured to output another prompt for requesting the large-scale language model to determine whether the image indicated by the image data extracted from the predetermined range data satisfies the exclusion condition to acquire a result of the determination indicating whether the exclusion condition is satisfied, as response data from the large-scale language model.

11. The information processing apparatus according to claim 1,
wherein the predetermined range data is data processed as one page when the document data is output as a printed matter.

12. The information processing apparatus according to claim 11, wherein the circuitry is further configured to:
classify a page included in the input document data as the first predetermined range data when the page is determined to satisfy the predetermined condition;
classify the page as the second predetermined range data when the first predetermined range data included in the document data is determined not to satisfy the predetermined condition;
extract an image area and a text area from the predetermined range data included in the document data;
acquire summary information of the image area and the summary information of the text area; and
determine whether the predetermined range data included in the document data satisfies the predetermined condition by using the summary information of the image area; and
wherein the predetermined condition is a condition that the image area extracted from the predetermined range data included in the document data includes at least one of the image area having insufficient summary information or image area having summary information having a relevance equal to or less than a threshold relative to summary information acquired from the text area.

13. The information processing apparatus according to claim 12, wherein the circuitry is further configured to:
generate the first search target data and the second search target data;
store the first search target data and the second search target data in a memory;
in a case where a page included in the document data is classified into the first predetermined range data, generate and store the first search target data, the first search target data including page image data indicating an image of the entire page and the summary information of the entire page that are associated; and
in a case where the page included in the document data is classified into the second predetermined range data, generate and store the second search target data, the second search target data including the summary information acquired from the image area and the text area for each of the image area and the text area extracted from the page.

14. The information processing apparatus according to claim 3, wherein the circuitry is further configured to:
generate screen information for displaying a result of classifying the predetermined range data included in the document data into the first predetermined range data or the second predetermined range data; and
output the screen information to the terminal device as an input source of the document data.

15. The information processing apparatus according to claim 14,
wherein the screen displayed based on the screen information is a screen for receiving editing of the classified result, and
wherein when the editing is performed on the result of the classification of the pages included in the document data on the screen, one of the first search target data and the second search target data is generated in accordance with the result of the classification of the pages included in the document data after the editing.

16. An information processing method comprising:
receiving input data input from a terminal device,
outputting, to a large-scale language model, a prompt requesting generation of output data corresponding to the input data, and
outputting, to the terminal device, response data to the prompt received from the large-scale language model,
wherein the prompt is a prompt requesting generation of the response data by searching a memory with the input data and using a search result as an information source,
the memory storing first search target data and second search target data,
the first search target data being generated for each of first predetermined range data satisfying a predetermined condition, among predetermined range data included in document data,
the second search target data being generated for each of data extracted from second predetermined range data not satisfying the predetermined condition, among the predetermined range data included in the document data.

17. An information processing system comprising:
an information processing apparatus; and
a terminal device to communicate with the information processing apparatus via a network,
the information processing apparatus including circuitry configured to receive input data input from the terminal device,
output, to a large-scale language model, a prompt requesting generation of output data corresponding to the input data, and
output, to the terminal device, response data to the prompt received from the large-scale language model,
wherein the prompt is a prompt requesting generation of the response data by searching a memory with the input data and using a search result as an information source,
the memory storing first search target data and second search target data,
the first search target data being generated for each of first predetermined range data satisfying a predetermined condition, among predetermined range data included in document data,
the second search target data being generated for each of data extracted from second predetermined range data not satisfying the predetermined condition, among the predetermined range data included in the document data, and
wherein the terminal device displays, on a display, the response received from the information processing apparatus.
